(19) United States
(12) Patent Application Publication
(10) Pub. No.: US 2006/0053916 A1
(43) Pub. Date: Mar. 16, 2006

(54) Automatic door opening and closing apparatus

(75) Inventors: Takeki Tanaka, Kawachi-gun (JP); Tomofumi Ichinose, Shioya-gun (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/212,378

(22) Filed: Aug. 26, 2005

(30) Foreign Application Priority Data
Aug. 31, 2004 (JP) 2004-252522

(51) Int. Cl. F16H 1/04

(52) U.S. Cl. 74/422

(57) ABSTRACT

An automatic door opening and closing apparatus includes: a movable portion that has a rectilinear rack that is moved reciprocally by a pinion, and a supporting portion that rotatably supports a planetary gear; a fixed rack that meshes with the planetary gear; and an arm that is mounted so as to be rotatable around a pin that is at a distance in a radial direction from a center of rotation of the planetary gear, and that is interposed between the pin and a tailgate. An automatic door opening and closing apparatus is provided that reduces dampening in the driving force that is caused by friction and improves the degree of design freedom.

### BACKGROUND OF THE INVENTION

1. Field of the Invention

Priority is claimed on Japanese Patent Application No. 2004-252522, filed Aug. 31, 2004, the contents of which are incorporated herein by reference.

The present invention relates to an automatic opening and closing apparatus for a door of a vehicle such as, for example, an automobile.

2. Description of Related Art

Conventionally, an automatic door opening and closing apparatus that opens and closes a tailgate of a vehicle such as an automobile using electric power is known. Among these automatic door opening and closing apparatuses are those whose apparatus body is fixed to a roof panel and is covered by lining or the like so as to be separate from the vehicle interior, and a tailgate is connected to an arm member that extends out from the apparatus body. However, in some cases, when the tailgate is open, the hole into which the arm member is inserted is particularly noticeable, so that there is a deterioration in the quality of the external appearance. Because of this, an apparatus has been proposed (see, for example, Japanese Patent Application Unexamined Publication No. 2002-174072) in which the hole is kept at the minimum possible size, and the arm member, which is formed in an arc shape centering on a hinge center of the tailgate, is provided so as to be able to slide inside a housing that has the same arc shape.

However, in the above described automatic door opening and closing apparatus, because a housing is provided that guides an arm member that has an arc-shaped trajectory, the problem arises that the driving force is dampened by friction between the arm member and the housing.

Moreover, because the number of components is increased as a result of the housing being provided, the problem arises that the number of assembly steps increases leading to increased costs.

Furthermore, if the trajectory of the arm member is altered, it is necessary to alter the design of both the arm member and the housing, so that the problem arises that the degree of design freedom is deteriorated.

Therefore, the present invention provides an automatic door opening and closing apparatus that reduces any dampening in the driving force that is caused by friction and also improves the degree of design freedom.

### SUMMARY OF THE INVENTION

In order to solve the above described problems, according to the present invention, there is provided an automatic door (for example, the tailgate 4 of the embodiment) opening and closing apparatus comprising: a movable portion (for example, the movable portion 28 of the embodiment) having a sliding portion (for example, the rectilinear rack 29 of the embodiment) that is moved reciprocally by a driving device (for example, the pinion 23 of the embodiment), and having a supporting portion (for example, the supporting portion 18 of the embodiment) that rotatably supports a gear member (for example, the planetary gear 16 of the embodiment); a fixed portion (for example, the fixed rack 12 of the embodiment) that meshes with the gear member; and an arm member (for example, the arm member 9 of the embodiment) that is mounted so as to be rotatable around a connecting point (for example, the pin 21 of the embodiment) that is at a distance in a radial direction from a center of rotation of the gear member, and that is interposed between the connecting point and a door.

With this structure, when the sliding portion moves reciprocally the connecting point of the gear member is displaced so as to describe an arc-shaped trajectory, and the arm member can be provided with an arc-shaped displacement.

Moreover, by, for example, changing the radius of the gear member, it is possible to easily change the distance between the center of rotation of the gear member and the connecting point. It is thus possible to freely change the arc-shaped trajectory of the arm member.

Furthermore, by using a gear member, it is possible to set a short transmission path for the driving force to the arm member. Therefore, a reduction in the size of the apparatus body can be achieved.

Preferably, in the above automatic door opening and closing apparatus, the sliding portion and the supporting portion are formed as a single body.

With this structure, the structure of the movable portion can be simplified and the rigidity thereof can be secured.

Preferably, in the above automatic door opening and closing apparatus, the movable portion moves reciprocally while being guided by a slide supporting portion (for example, the horizontal portion 13 of the embodiment) of the fixed portion that meshes with the gear member.

With this structure, by making the fixed portion that meshes with the gear member also function as the slide guiding member for the movable portion, it is possible to decrease the number of component parts.

Preferably, in the above automatic door opening and closing apparatus, one of the movable portion and the slide supporting portion has a T-shaped cross section and engages with the other of the movable portion and the slide supporting portion.

With this structure, because the positions of two directions that are orthogonal to the slide direction of the movable portion, for example, if this apparatus is used in a tailgate, the up-down and left-right directions of the vehicle, are fixed, the sliding of the movable portion can be stabilized.

### BRIEF DESCRIPTION THE DRAWINGS

FIG. 1 is a side view showing a rear portion of a vehicle that is equipped with the power tailgate of an embodiment of this invention, and shows a state in which the tailgate is fully closed.

FIG. 2 is a side view showing a rear portion of a vehicle that is equipped with the power tailgate of an embodiment of this invention, and shows a state in which the tailgate is fully open.

FIG. 3 is a typical view showing the power tailgate apparatus of an embodiment of this invention.

FIG. 4 is a cross-sectional view taken along a line A-A in FIG. 3 of an embodiment of this invention.

FIG. 5 is a typical view showing another aspect of an embodiment of this invention.

### DETAILED DESCRIPTION OF THE INVENTION

An embodiment of this invention will now be described together with the drawings. Note that a case is described in which this embodiment is applied to the tailgate of an automobile and, particularly, of a station wagon.

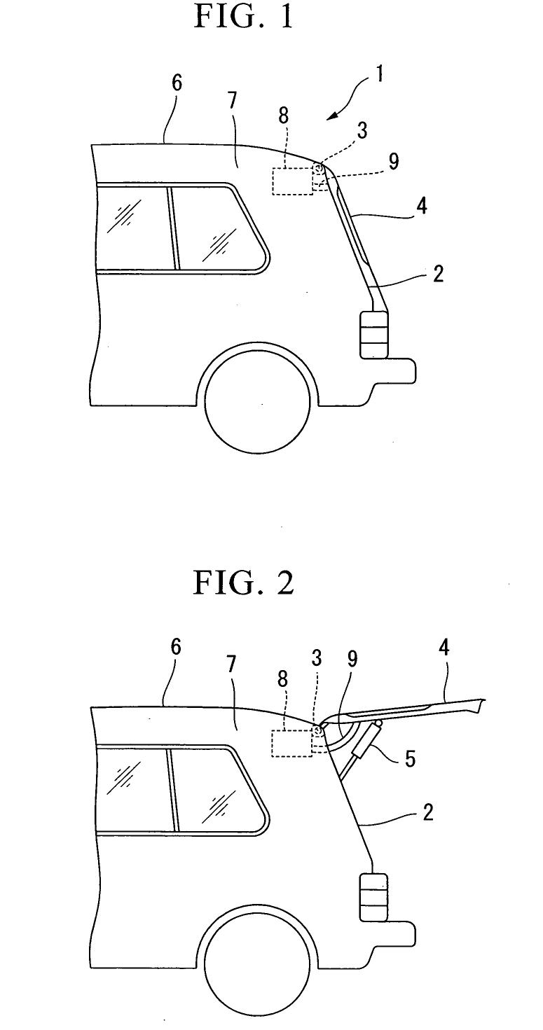

As is shown in FIGS. 1 and 2, a rear aperture portion 2 is formed in a rear portion of a vehicle body 1. A tailgate (i.e., a door) 4 is provided at a top edge of the rear aperture portion 2 so as to be able to open and close freely via a hinge 3. A gas spring 5 is connected to the tailgate 4, and the gravitational balance is adjusted by the urging force of the gas spring 5 when the tailgate is being opened or closed. Here, the tailgate 4 swings around a hinge center of a hinge 3 whose axis runs in the vehicle transverse direction between the fully closed state shown in FIG. 1 and the fully open state shown in FIG. 2.

As is shown in FIGS. 1 to 3, a roof side rail 7, which is a frame member, is provided on both sides on a roof panel 6 of the vehicle body 1. An apparatus body 8 of the power tailgate apparatus is provided inside the roof side rail 7. An arm (i.e., an arm member) 9 is attached to the apparatus body 8, and a distal end of this arm 9 is rotatably attached to a top portion on the vehicle interior side of the tailgate 4. In addition, a lining 10 is provided that covers the roof panel 6 and the roof side rail 7 from the vehicle interior side, and an aperture portion 11 into which the arm 9 is inserted is formed in the lining 10 on the tailgate 4 side thereof.

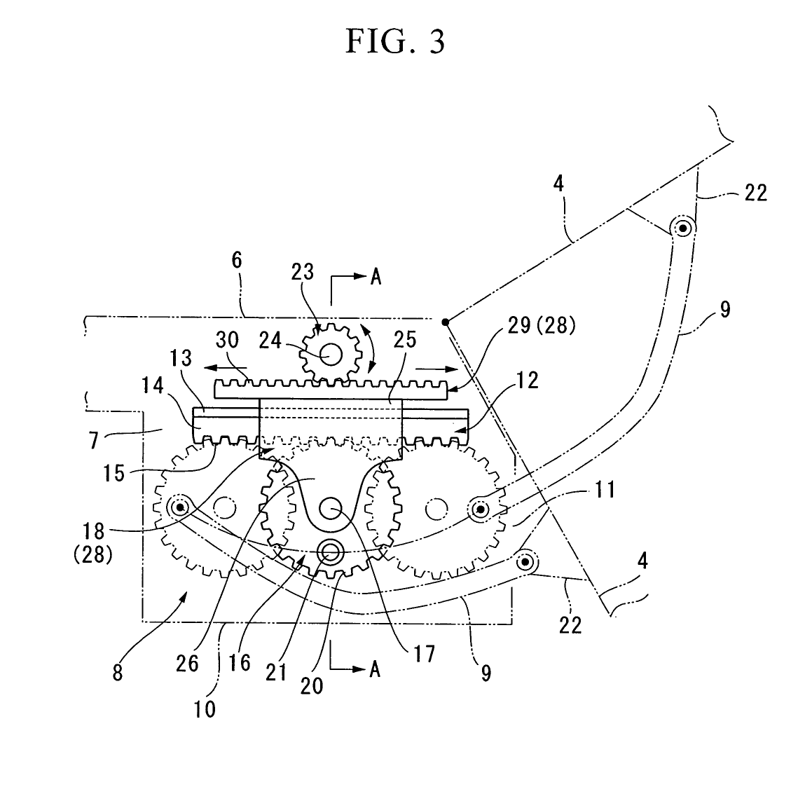

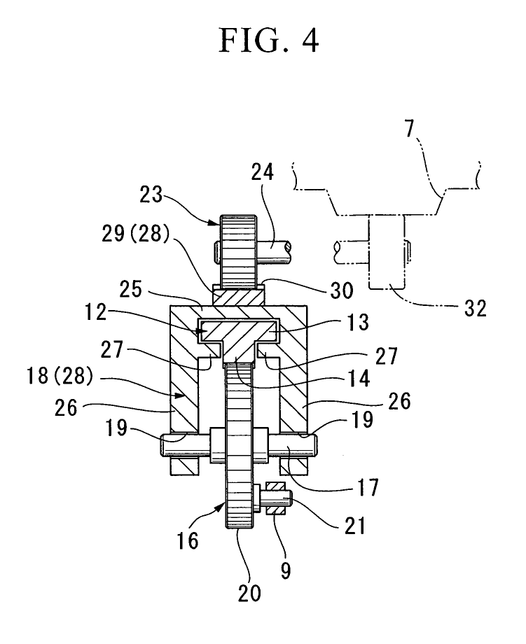

As is shown in typical view in FIGS. 3 and 4, a rod-shaped fixed rack (i.e., a fixed portion) 12 is provided on the apparatus body 8. This rack 12 is formed having a T-shaped cross section that is formed by a horizontal portion (i.e., a slide support portion) 13 and a vertical portion 14, and is fixed to the roof side rail 7 while being aligned in the vehicle longitudinal direction. Moreover, teeth 15 are formed on a bottom surface of the vertical portion 14 of the fixed rack 12, and a planetary gear (i.e., a gear member) 16 is positioned below the fixed rack 12. The planetary gear 16 is a disc-shaped gear that has a rotation shaft 17 that extends in the vehicle transverse direction. The rotation shaft 17 is provided so as to be supported by a bearing 19 of a supporting portion 18 that is described below. The teeth 15 of the fixed rack 12 mesh together with teeth 20 of the planetary gear 16.

A pin (i.e., a linking portion) 21 that extends in the vehicle transverse direction is formed on a left side (i.e., the side facing towards a person viewing FIG. 3) of the planetary gear 16 in substantially a center portion between the rotation shaft 17 of the planetary gear 16 and an outer circumference of the planetary gear 16.

One end of the arm 9 that is formed so as to bend gently upwards is rotatably supported by the hinge pin 21. The other end of this arm 9 is rotatably supported via a bracket 22 at a surface of the tailgate 4 (shown in typical view in FIG. 3) that is on the vehicle interior side. Namely, because the pin 21 is provided extending in the vehicle transverse direction, displacement in the left-right direction of the arm 9 is restricted, and the arm 9 is able to travel along a stable trajectory. Here, in a state in which the planetary gear 16 is in an intermediate position along this movement stroke, the pin 21 is positioned on an extended line that joins an input shaft 24 of a pinion (i.e., a drive device) 23 that is described below and the rotation shaft 17 of the planetary gear 16. This position is the lowest point of displacement of the pin 21. Note that the pin 21 may also be formed on the right side surface of the planetary gear 16.

The supporting portion 18 is formed by a shoulder portion 25 that is located above the fixed rack 12, and extended portions 26 and 26 that each extend downwards from both the left and right side edges of the shoulder portion 25. The bearing 19 that supports the rotation shaft 17 of the planetary gear 16 (described above) is formed in a bottom portion of each extended portion 26. Furthermore, engaging portions 27 and 27 are provided facing each other at an inner side of top portions of the extended portions 26. The horizontal portion 13 of the fixed rack 12 is housed in a space that is formed by the engaging portions 27 and the shoulder portion 25. The horizontal portion 13 consequently performs the function of a rail so that the supporting portion 18 is able to slide freely in the vehicle longitudinal direction. In addition, the vertical portion 14 is located extending downwards between the respective engaging portions 27 and 27. Namely, displacement of the supporting portion 18 in the up-down and left-right directions is restricted while sliding thereof in the vehicle longitudinal direction is allowed.

A rectilinear rack (i.e., a slide portion) 29 that together with the supporting portion 18 constitutes a movable portion 28 is formed integrally with a top portion of the supporting portion 18. The rectilinear rack 29 is formed in a rod shape, and is positioned so as to be aligned with the fixed rack 12. Teeth 30 are formed on a top surface of the rectilinear rack 29, and the pinion 23 is placed above these teeth. The pinion 23 is formed in a columnar shape that extends in the vehicle transverse direction, and teeth 31 are formed on a circumference of the pinion 23. The teeth 30 of the rectilinear rack 29 and the teeth 31 of the pinion 23 mesh together. Note that it is also possible to provide the rectilinear rack 29 and the supporting portion 18 as separate components and to fix the rectilinear rack 29 to the supporting portion 18.

One end of the input shaft 24 that runs in the vehicle transverse direction is fixed to the pinion 23. An electric motor 32 is connected to the other end of the input shaft 24 and the electric motor 32 is fixed to the roof side rail 7. Namely, because the input shaft 24 of the pinion 23 is fixed via the electric motor 32 to the roof side rail 7, when the pinion 23 is rotated by the electric motor 32, only the rectilinear rack 29 slides in the longitudinal direction along the fixed rack 12 and there is no change in the position of the pinion 23. What is known as a rack and pinion is formed by the pinion 23 and the rectilinear rack 29.

Namely, if the pinion 23 is rotated by switching on the electric motor 32 in order to change the tailgate 4 from a fully closed state to a fully open state, the rectilinear rack 29 and the supporting portion 18 that had hitherto been positioned on the vehicle forward side slide to the vehicle rearward side. In the same way, the planetary gear 16 that is supported by the supporting portion 18 also rolls along the fixed rack 12 from the vehicle forward side so as to move to the vehicle rearward side. At this time, because the trajectory of the pin 21 is the same as that of a so-called cycloid, which is the track of a point on the circumference of a circle as the circle rolls along a straight line, one end of the arm 9 that is supported by the pin 21 is displaced while describing a downward-facing convex arc (indicated by the chain line in FIG. 3).

In addition, as the one end of the arm 9 is displaced while tracing an arc, the other end of the arm 9 pushes up the tailgate 4 while describing an arc that is centered on the hinge center of the hinge 3. Accordingly, the tailgate 4 swings from a fully closed position to a fully open position.

On the other hand, when the tailgate 4 is swung from a fully open state to a fully closed state, by rotating the pinion 23 in reverse using the electric motor 32, the rectilinear rack 29 slides from the vehicle rearward side to the vehicle forward side. In addition, conversely from when the tailgate 4 is swung from a fully closed position to a fully open position, the one end of the arm 9 is displaced from the vehicle rearward side to the vehicle forward side while describing an arc, so that the other end of the arm 9 pulls the tailgate 4 to the vehicle interior side and the tailgate 4 is swung from a fully open position to a fully closed position.

As a result, according to the above described embodiment, because the pin 21 of the planetary gear 16 is displaced so as to describe an arc-shaped trajectory when the rectilinear rack 29 is moved reciprocally, so that it is possible to furnish the one end of the arm 9 with an arc-shaped displacement, the aperture portion 11 can be reduced to the minimum possible size so that the quality of the external appearance thereof can be improved. In addition, any dampening of the drive force that is caused by friction can be suppressed.

Moreover, by changing the distance between the rotation shaft 17 of the planetary gear 16 and the pin 21, it is possible to freely change the curvature of the arc described by the one end of the arm 9, thereby enabling the degree of design freedom to be improved.

Furthermore, while a simplification of the structure of the movable portion 28 that is made up of the rectilinear rack 29 and the supporting portion 18 is achieved, the rigidity thereof can also be secured. In addition, the size of the apparatus body 8 can be further reduced.

Moreover, if the fixed rack 12 that meshes with the planetary gear 16 doubles as a slide guide member for the supporting portion 18, the number of components can be decreased. As a result, the number of assembly steps can be decreased so that the load on an operator is lightened.

Furthermore, because the position of the supporting portion 18 is fixed in the up-down and left-right directions, the supporting portion 18 can be made to slide in a stable fashion thereby improving the reliability of an opening or closing operation.

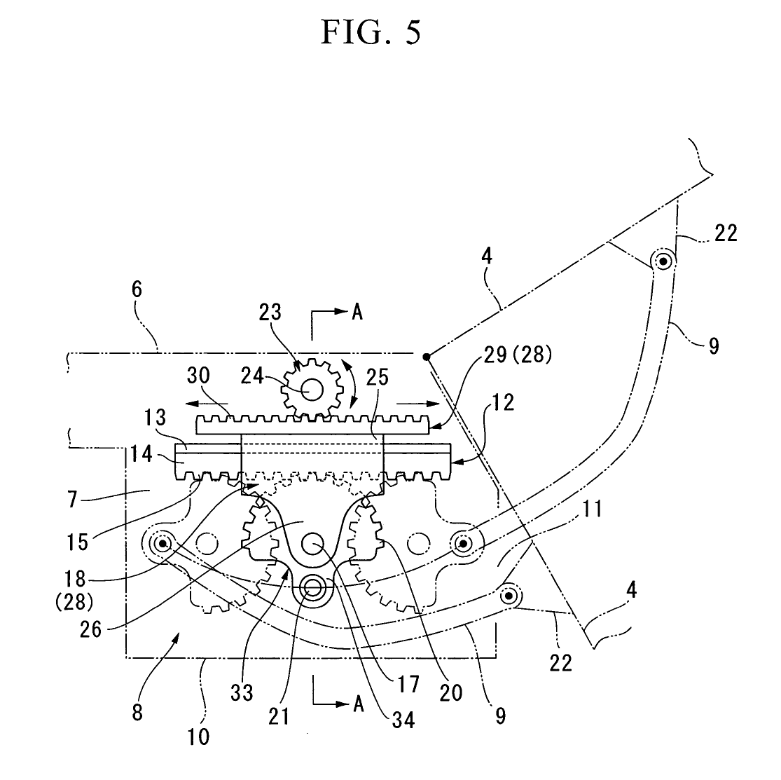

Next, another aspect of the present embodiment will be described based on FIG. 5. FIG. 5 shows a case in which the planetary gear shown in FIG. 3 has been replaced with what is known as a sector gear.

As is shown in FIG. 5, a sector gear 33 is a gear in which teeth are only formed on an outer circumferential portion of what is substantially a semicircle that, if, for example, the planetary gear 16 described in the above embodiment were to be rotated, is the portion that meshes with the teeth 20 of the fixed rack 12. A rod portion 34 is formed on a rectilinear portion of the substantially semicircle protruding outwards from substantially a center of this rectilinear portion. The pin 21, by which one end of the arm 9 is supported in the same way as in the above described planetary gear 16, is formed in an end portion of this rod portion 34. Note that the remainder of the structure of this sector gear 33 is the same as in the above described embodiment and a description thereof is consequently omitted.

As a result, according to the above other aspect of the described embodiment, because the weight especially is reduced compared to when the planetary gear 16 is used by employing a structure that uses the sector gear 33, an improvement in fuel consumption can be achieved.

Moreover, the further advantage is achieved that the curvature of the above described arc can be easily changed simply by changing the length of the rod portion 34.

Note that the present invention is not limited to the above described embodiment and it may also be applied to doors other than tailgates such as side doors. Furthermore, it can also be used for doors other than those of vehicles and lids and the like provided that they swing open and closed.

According to one embodiment of the present invention, when the slide portion is moved reciprocally, because the connecting point of the gear member is displaced so as to describe an arc-shaped trajectory and the arm member can be provided with an arc-shaped displacement, the effect is obtained that it is possible to suppress any dampening of the drive force that is caused by friction.

Moreover, for example, because it is possible by changing the diameter of the gear member to easily change the distance between the center of rotation of the gear member and the connecting point, the arc-shaped trajectory of the arm member can be feely changed. Accordingly, the effect is obtained that the degree of design freedom is improved.

Furthermore, because it is possible by using a gear member to set a short transmission path for the driving force to the arm member, a reduction in the size of the apparatus body can be achieved. Accordingly, the effect is obtained that it is possible to secure a wider space on the door inner side.

According to another embodiment of the present invention, because the structure of the movable portion can be simplified and the rigidity thereof can be improved, the effect is obtained that a further reduction in the size of the apparatus becomes possible.

According to still another embodiment of the present invention, because it is possible to decrease the number of component parts by making the fixed portion that meshes with the gear member also function as the slide guiding member for the movable portion, the effect is obtained that the number of assembly steps can be decreased and the load on an operator can be lightened.

According yet another embodiment of the present invention, because the positions of two directions that are orthogonal to the slide direction of the movable portion, for example, if this apparatus is used in a tailgate, the up-down and left-right directions of the vehicle, are fixed, the sliding of the movable portion can be stabilized. Accordingly, the effect is obtained that the reliability of the apparatus can be improved.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. An automatic door opening and closing apparatus comprising:
a movable portion having a sliding portion that is moved reciprocally by a driving device, and having a supporting portion that rotatably supports a gear member;
a fixed portion that meshes with the gear member; and
an arm member that is mounted so as to be rotatable around a connecting point that is at a distance in a radial direction from a center of rotation of the gear member, and that is interposed between the connecting point and a door.

2. The automatic door opening and closing apparatus according to claim 1, wherein the sliding portion and the supporting portion are formed as a single body.

3. The automatic door opening and closing apparatus according to claim 1, wherein the movable portion moves reciprocally while being guided by a slide supporting portion of the fixed portion that meshes with the gear member.

4. The automatic door opening and closing apparatus according to claim 2, wherein the movable portion moves reciprocally while being guided by a slide supporting portion of the fixed portion that meshes with the gear member.

5. The automatic door opening and closing apparatus according to claim 3, wherein one of the movable portion and the slide supporting portion has a T-shaped cross section and engages with the other of the movable portion and the slide supporting portion.

6. The automatic door opening and closing apparatus according to claim 4, wherein one of the movable portion and the slide supporting portion has a T-shaped cross section and engages with the other of the movable portion and the slide supporting portion.
